(19) United States
(12) Patent Application Publication
(10) Pub. No.: US 2014/0040441 A1
(43) Pub. Date: Feb. 6, 2014

(54) SYSTEM AND METHOD FOR THE CONFIGURATION OF A CLUSTERED SIMULATION NETWORK

(71) Applicant: ABB TECHNOLOGY AG, Zurich (CH)

(72) Inventors: Jürgen Greifeneder, Mannheim (DE); Marlo Hoernicke, Landau (DE); Oliver Gramberg, Zurich (CH)

(73) Assignee: ABB TECHNOLOGY AG, Zurich (CH)

(21) Appl. No.: 14/047,803

(22) Filed: Oct. 7, 2013

Related U.S. Application Data
(63) Continuation of application No. PCT/EP2012/001389, filed on Mar. 29, 2012.

(30) Foreign Application Priority Data
Apr. 6, 2011 (EP) 11002870.1

(51) Int. Cl. H04L 12/24

(52) U.S. Cl. CPC H04L 41/0803
USPC 709/220

(57) ABSTRACT

A system and method are provided for configuring a clustered simulation network using virtualization. A user configures access to the main engineering personal computer (PC) being used for the plant solution, and the user configures the physical host PCs which are used for performing virtual machines containing simulators. The user selects the objects that should be simulated and based on the engineering data that the engineering PC provides, a framework application is provided to configure the required simulators, the required network interface, and the required IP addresses as well as the load balancing of the simulation tools, the required number of virtual machines which perform the simulators, and the distribution of virtual machines to the physical PCs.

### RELATED APPLICATIONS

This application claims priority as a continuation application under 35 U.S.C. §120 to PCT/EP2012/001389, which was filed as an International Application on Mar. 29, 2012 designating the U.S., and which claims priority to European Application 11002870.1 filed in Europe on Apr. 6, 2011. The entire contents of these applications are hereby incorporated by reference in their entireties.

### FIELD

The present disclosure relates to a system for the configuration of a clustered simulation network which provides a domain- and technology-independent simulation framework to engineer and configure a clustered simulation network from a single point of access, by utilizing virtualization technology for the purpose of distribution, automatic configuration and load management. The present disclosure also relates to a method for the same.

### BACKGROUND INFORMATION

Simulation is widely used during factory acceptance testing (FAT hereafter) of process and manufacturing plants to check for the functionality and verification of the plant solution when the control, device and subsystem hardware is still not available and devices are not present.

In known techniques, there are different simulation tools being used for different automation technologies, for example, for IEC61850 which is a standard for the design of electrical substation automation, for example, a general communications protocol for protection and process control, and are used for subsystem and device simulation and distributed control system (DCS hereafter) simulation.

However, there is no known system and method that provides an efficient configuration method of different simulation technologies from a single platform or simulation configuration framework.

Simulation tools for process and manufacturing plants are widely used in order to provide a test platform for developed solutions before the subsystems and devices are present and/or installed. For several types of devices, such as controllers, programmable logic controllers (PLC), field busses and other kinds of physical systems inside a plant automation system, different simulators or emulators are available to provide a software representation for the physical device.

These tools are sometimes connected to the process control system and sometimes are not. Each of those tools provides different interfaces for connection to other simulation tools or higher order process simulators, as shown in FIG. 1.

Therefore, there is no common interface to the simulators and there is no common configuration method to deploy the simulators for the purpose of FAT or virtual commissioning.

Furthermore, the user of the simulation tools has to configure and execute each simulator separately and with a proprietary graphical user interface (GUI). As a result, there is a usability problem regarding the engineering and deployment of the simulators: there is no common point of access to the configuration interface of the simulators.

For larger plant solutions, the user has to split the simulation into different parts and deploy the tools on several computers (hereafter “PCs”, as an example of a type of computer) in order to have enough processing power for the simulation. This results in a network of simulators that is clustered to several PCs. Each of those PCs has to provide the required hardware to execute the simulator(s).

This perhaps means that several network adapters, for example, Ethernet cards, have to be installed and these adapters have to be configured to be placed in the correct network. Thus, in addition to the usability problem, the user has to take care of the distribution of the simulators, the PC hardware required to execute them and the network setup of the simulation PCs.

The current process has a variety of drawbacks which are listed in the following:

1. It is hard to synchronize control and orchestration commands between the simulators.

2. There is no defined process for developing the simulation network. The configuration depends on the engineer developing it. This can lead to inconsistencies between the PCs, the real hardware and the simulation.

3. Special hardware has to be provided, such as at least a bunch of Ethernet cards, in order to make the simulators executable and working on the simulation PCs.

4. There is a lot of manual work for configuring the simulation network and the hardware that is required for the simulators.

5. A lot of physical PCs are required for large solutions, because of the hardware interfaces required for the simulators. This is usually not a performance or memory problem, but a connectivity problem—missing network interfaces (NIC hereafter) or not enough Peripheral Component Interconnect (PCI) slots on the mainboard to increase the number of NIC.

6. There is bad usability, because every simulator provides a special GUI that is tailored for it and not for the user's needs.

7. The simulation tools provide different functionality: for example, a simulator can be frozen, while another one cannot be frozen. This leads to technology problems and inconsistencies during runtime—for example, one simulator is performed, another one is frozen, but both need to communicate to each other during operation.

8. Every simulator has to be configured with its own data and separately. There is no way to make a bulk configuration of all executed simulators, although the required information is present.

9. Several systems have to be set up on different systems and the software must be kept to the same version on each of them.

Keeping this in mind and being aware of the drawbacks associated with performing the simulation of a clustered simulation network, exemplary embodiments of the present disclosure provide a system and method for the engineering and configuration of such clustered simulation network using virtualization which provides easy access and control for a user.

EP1906377 A1 discloses a system and method for integrating a process control system into a training simulator, where the system has a training simulator that interacts with a virtual personal computer (VPC), such that the functionalities for a simulation are actuated through an interface. The virtual PC stores a piece of software for modelling a technical installation or a technical process, and for modelling the user interface of a process control system.

Furthermore, a method and installation for complete simulation or simulation in part and/or simulation of an automated system has been proposed, wherein a real automation device is substituted by a simulated device in that way such that a modified or an unmodified software of the real device is implementable or feasible by means of an emulation and/or virtualization environment.

### SUMMARY

An exemplary embodiment of the present disclosure provides a system for engineering a clustered simulation network using virtualization. The exemplary system includes a main engineering personal computer (PC) being used for a plant solution and having user-configured access thereto. In addition, the exemplary system includes physical host PCs configured to perform virtual PCs, which include (a) simulators which are user-configured to simulate physical systems of a plant automation system, (b) simulators configured to perform virtual network adapters for simulators of physical systems, and (c) simulation tools to control the simulators. The exemplary system also includes engineering data including information about a control, device and subsystem solution and corresponding logic behind the physical systems of the plant automation system stored in the engineering PC. Furthermore, the exemplary system includes a framework application, which is, based on the engineering data received from the engineering PC, provided for a configuration of required simulators, a required network interface, required virtual PCs and virtual hardware, and required IP addresses. The framework application is configured to require a number of virtual PCs configured to perform simulation tools, and distribution of virtual PCs to the physical PCs. The virtual PCs contain simulators of different types, interface and control functionality.

An exemplary embodiment of the present disclosure provides a method for engineering a clustered simulation network using virtualization. The exemplary method includes configuring user access to a main engineering computer (PC) being used for a plant solution, configuring user-configured physical host PCs for performing virtual PCs containing simulators, and selecting user-configured physical systems of a plant automation system for simulation. In the exemplary method, based on engineering data including information about a control, device and subsystem solution and corresponding logic behind the physical systems of the plant automation system stored in the engineering PC, a framework application (a) extracts required simulators, required network interfaces, required virtual PCs and required IP addresses, as well as a configuration of the virtual PCs and virtual hardware, (b) distributes and configures the simulators, network interfaces and IP addresses to the virtual PCs, and (c) distributes and configures the virtual PCs to the physical host PCs. The required number of virtual machines which perform simulation tools, and the distribution of virtual PCs to the physical PCs are configured by the framework application providing an appropriate load balancing which is calculated to distribute the virtual PCs to several host PCs. The simulators are instantiated according to a load balancing scheme.

### BRIEF DESCRIPTION OF THE DRAWINGS

Additional refinements, advantages and features of the present disclosure are described in more detail below with reference to exemplary embodiments illustrated in the drawings, in which:

FIG. 1 illustrates a configuration of known simulation tools;

FIG. 2 illustrates a small and simple simulation network for a plant solution, according to an exemplary embodiment of the present disclosure; and

FIG. 3 illustrates a process configuring simulation using virtual machines, according to an exemplary embodiment of the present disclosure.

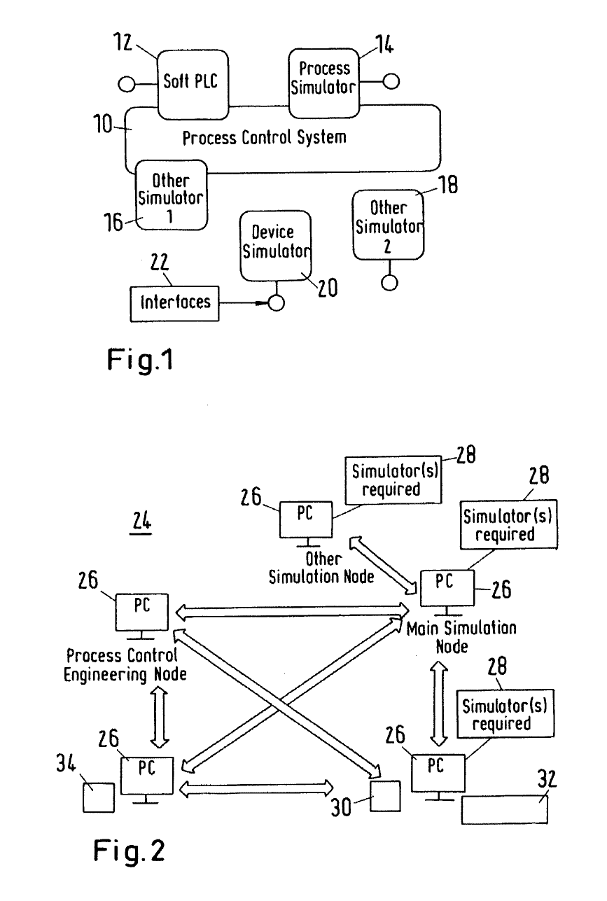

Accordingly, with the exception of FIG. 1 which reveals a known configuration, all other drawings show exemplary embodiments of the present disclosure.

### DETAILED DESCRIPTION

Exemplary embodiments of the present disclosure is related to a method and a system providing a domain- and technology-independent simulation framework to engineer and configure a clustered simulation network from a single point of access, by utilizing virtualization technology for the purpose of distribution, automatic configuration and load management

To that effect, the system according to an exemplary embodiment of the present disclosure includes the following components: a user configures the access to the main engineering personal computer (PC) being used for the plant solution, the user configures the physical host PCs which are used for performing the virtual machines containing the simulators, the user selects the objects that should be simulated and based on the engineering data that the engineering PC provides, and a framework application is provided to configure the required simulators, the required network interface, and the required IP addresses as well as the load balancing of the simulation tools, the required number of virtual machines, and the distribution of the simulation virtual machines to the physical PCs.

The present disclosure provides for the use of virtualization technology for providing a method and a system for an efficient engineering and configuration of simulators that are located in a simulation network or cluster. These simulators can be of different types and do not necessarily have to provide the same interfaces and control functionality. Additionally, the simulators do not have to provide similar configuration methods. Hence, this is a very open method that can be used for several types of simulators.

According to an exemplary embodiment of the present disclosure, the system includes the setup of the simulation network itself, the implementation of the configuration of the simulators into each simulator to set those up and make them performing the engineered control solution, the configuration of the communication between the simulators and finally perform the FAT on the simulation network.

According to an exemplary embodiment of the present disclosure, the engineering is provided without any framework application, whereas the user has a defined set of actions to be executed.

In accordance with an exemplary embodiment, the user performs the orchestration (e.g., configuration) commands either from the graphical user interface (GUI) of the virtual machine hypervisor or controls them remotely via a framework application.

In accordance with an exemplary embodiment of the present disclosure, there is no need to buy, mount and configure special hardware, especially network adapters such as ethernet cards, for example, in the physical PC due to networks which are tunneled through the hypervisors hardware abstraction layer.

Accordingly, it is possible to base the engineering on a defined standard workflow for all simulation tools, whereas every simulation tool inside the framework can be engineered by the simulation engineer being familiar with that.

An advantageous feature of the system according to the present disclosure provides an appropriate load balancing which is calculated to distribute the virtual machines executing the simulators to several host PCs, where the appropriate load balancing of the simulation tools inside the virtual machines being assigned to a specific host PC is calculated.

Furthermore, the simulation tools inside the VMs can be instantiated according to the load balancing scheme or as defined by the user. A minimum number of host PCs required to perform the simulation can be calculated by means of predefined metrics.

According to an exemplary embodiment of the present disclosure, the simulators' control commands are utilized to distribute and synchronize the simulators throughout the simulation network. The virtual machine hypervisor's orchestration commands are utilized to extend existing simulation tools with further control functionality.

In accordance with an exemplary embodiment, the configuration of a clustered simulation network provides communication between the orchestration interface and the simulation tools whereas the virtual machine hypervisor is provided in a networked manner.

Likewise, the system according to an exemplary embodiment of the present disclosure provides that the simulators or simulation VMs or physical PCs can be added or removed from the simulation network while the simulation is executed without stopping or interrupting the execution of the simulation.

An exemplary embodiment of the present disclosure provides a method in which the access to a main engineering PC being used for the plant solution is configured by a user, the physical host PCs being used for performing the virtual machines containing the simulators is also configured by the user, the objects that should be simulated are selected by the user, and based on the engineering data provided by the engineering PC, the required simulators, the required network interface, the required IP addresses, as well as the configuration of the virtual PC(s) and the virtual hardware and simulators are extracted.

According to an exemplary embodiment of the method, the simulation network itself first is set up, then the configuration of the simulators is put into each simulator to set those up and make them performing the engineered control solution, then the communication between the simulators is configured, and finally the test procedures, verification and validation of the solution can be performed.

According to an exemplary embodiment, the orchestration (e.g., configuration) is performed by the user from the graphical user interface (GUI) of the virtual machine hypervisor or remotely controlled via a framework application.

For example, there is no need to buy, mount and configure special hardware, especially network adapters such as Ethernet cards, for example, in the physical PC due to networks which are tunneled through the hypervisors hardware abstraction layer.

According to an exemplary embodiment of the present disclosure, the engineering is based on a defined standard workflow for all simulation tools whereas every simulation tool inside the framework is provided to be engineered by the simulation engineer being familiar with that.

According to an exemplary embodiment, the engineering is provided without any framework application, whereas a defined set of actions has to be executed by the user. An exemplary embodiment of the present disclosure provides that there is no need to buy, mount and configure special hardware, especially network adapters such as ethernet cards, for example, in the physical PC due to networks which are tunneled through the hypervisors hardware abstraction layer.

Likewise, the engineering can be based, for example, on a defined standard workflow for all simulation tools and whereas every simulation tool inside the framework can be engineered by the simulation engineer being familiar with that.

An exemplary embodiment of the present disclosure provides that an appropriate load balancing is calculated to distribute the virtual machines executing the simulators to several host PCs. An appropriate load balancing of the simulation tools inside the virtual machines being assigned to a specific host PC is calculated.

Furthermore, the simulation tools inside the VMs can be instantiated according to the load balancing scheme or as defined by the user.

An exemplary embodiment of the present disclosure provides a minimum number of host PCs required to perform the simulation is calculated by means of predefined metrics.

Likewise, the simulators' control commands are utilized to distribute and synchronize the simulators throughout the simulation network.

According to an exemplary embodiment of the present disclosure, the virtual machine hypervisor's orchestration commands can be utilized to extend existing simulation tools with further control functionality.

According to an exemplary embodiment, a method for the configuration of a clustered simulation network provides communication between the orchestration interface and the simulation tools and the virtual machine hypervisors being provided in a networked manner.

A method according to an exemplary embodiment of the present disclosure provides simulators or simulation VMs or physical PCs which are added or removed from the simulation network while the simulation is executed without stopping or interrupting the execution of the simulation.

For the virtualization, it is useful to provide a standard PC where the simulators are installed. Hence, this virtual machine (VM) is provided as template and can therefore easily be shared across several PCs or can be instantiated on a single PC multiple times. If any new simulation tool has to be integrated, it is installed in the virtual machine and a simple plug-in infrastructure shows the framework that the simulation tool is present now and can be used for the simulation of a device or network engineered in a plant solution.

If a simulator is required, either the virtual machine is just executed, or a copy or clone is made and a new “instance” of the simulator is created. By doing so, the simulators are automatically multiplied and can be executed by executing the VM.

For the engineering part, virtualization provides an appropriate infrastructure, which can be used to manually or automatically configure and use virtual network adapters and other hardware that is required for the simulator.

Most simulators require a network interface controller (NIC) in order to operate properly and to be executable on a PC. These NIC, for example, Ethernet cards, easily can be added without changing hardware of the physical PC. The simulation PC is mostly independent from the hardware of its host PC. This makes the simulation very flexible and easy to extend with further simulators and easy to change the NIC of a simulation PC.

In addition to the easy change of the virtual hardware, the virtual PC or virtual PCs performing the simulation can easily being preconfigured and distributed to several physical host PCs. By simply copying the virtual machine to a different PC, the simulation can be performed there without changing anything in the virtual machine, the hardware of the host PC, or the configuration of both. The simulation will perform directly with only very minor changes in the hypervisor or even without any changes.

Additionally, the virtualization technology is used to extend the existing simulator functionality by some standard functions. Usually, a virtualization hypervisor is able to save snapshots, suspend a virtual machine or to pause a virtual machine. By processing these commands on the virtual machine using the hypervisor, the simulation tools that are executed inside the virtual machine perform the same actions without changing the functionality of those. That means there is an easy way to make a simulation tool able to store snapshots, suspend and pause simulation without touching the functionality of the simulation tool itself.

All this leads to a standard method that can be used to configure simulation solutions of a plant:

The user configures the physical PCs that shall be used for the simulation.

The user configures the access to the engineering PC containing the information about the control, device and subsystem solution and the corresponding logic behind that.

The user chooses the objects that shall be simulated within the simulation network.

The simulation framework takes care of evaluating the data gather from the engineering PC and calculates the required virtual Ethernet cards, IP addresses and virtual machines required for the objects to be simulated.

The framework automatically distributes the simulators on the virtual machines or virtual machine instance and distributes the virtual machines on the given physical PCs.

Once the simulation network itself is set up, the user can put the configuration of the simulators into the simulators to set them up and make them performing the engineered control solution. Additionally, the communication between the simulators should immediately work, because the framework already deployed the virtual Ethernet cards and set the IP addresses of those. Then the test, verification and validation of the plant solution can begin.

The user performs the orchestration commands either from the GUI of the virtual machine hypervisor or remote controls them via a framework application.

In the following some specific advantages of the disclosure are made up.

There is no need to buy, mount and configure special hardware, for example, Ethernet cards in the physical PC—networks and other PC hardware dependent stuff is tunneled through the hypervisors hardware abstraction layer.

Engineering bases on a defined standard workflow for all simulation tools. Once the simulation engineer is familiar with it, he can engineer every simulation tool inside the framework.

Most steps of the configuration can be automated, which increases efficiency of the simulation configuration.

Simulators can be configured with the required data from a single point—most configurations can be done automatically and the look and feel of the simulation tools is the same for each simulator.

Missing functionality is “upgraded” by using the hypervisor to perform orchestration actions (suspend, pause, take snapshots, etc.).

Much better usability by providing a framework application that is tailored for the user and not for the simulation functionality. Additionally, the GUI is the same for all simulators.

Orchestration commands can be synchronized using the hypervisors functionality—at least for the orchestration commands provided by the hypervisor.

Simple algorithms can be used to calculate a load balancing of the physical PCs and the virtual machines.

The described method is very flexible and is open enough to integrate several different kinds of simulation technologies across technology borders.

FIG. 1 shows a representative, known arrangement of tools for the simulation of processes and/or manufacturing plants consisting of a process control system 10. In addition, some components for example, “SoftPLC” 12, “Process Simulator” 14, “Other Simulator 1” 16, “Other Simulator 2” 18, and “Device Simulator” 20 are provided with interfaces 22 for enabling cooperation between such components.

It is a drawback that the user of the simulation tools has to configure and execute each simulator separately and with a proprietary graphical user interface. As a result, there is a usability problem regarding the engineering and deployment of the simulators, namely that there is no common point of access to the engineering interface of the simulators.

For larger plant solutions, the user has to split the simulation into different parts and deploy the tools on several PCs in order to have enough processing power for the simulation. This results in a network of simulators that is clustered to several PCs.

As used herein, the term “tool” means one or more PCs having at least one non-transitory computer-readable recording medium (e.g., a ROM, hard disk drive, flash memory, etc.), a working memory such as RAM, and at least one processor (e.g., general purpose or application specific) which is configured to execute a computer program or other computer-readable instructions tangibly recorded on the non-transitory computer-readable recording medium for carrying out the operative functions of that tool. Accordingly, for clarity of illustration, the tools will be described herein with respect to the operations they respectively perform. However, it is to be understood that the tools are each hardware implementations such as a PC, part of the processing functions of a PC, or multiple PCs, as set forth below.

FIG. 2 shows an example of a simulation network 24 for a plant solution according to an exemplary embodiment of the present disclosure which is rather small and simple. It includes a number of PCs (personal computers) 26 whereas each of the PCs 26 being used for this simulation network 24 has to provide the required hardware to execute the simulation.

Thus, in addition to the usability problem, the user has to take care of the distribution of simulators 28 whereas each is established in a PC 26. Accordingly, the hardware of the PC 26 is respectively required to execute the simulation as well as the network setup of the simulation PCs 26. Furthermore, according to an exemplary embodiment, there can be a simulation operator 30, another simulation node 32 and another process control node 34.

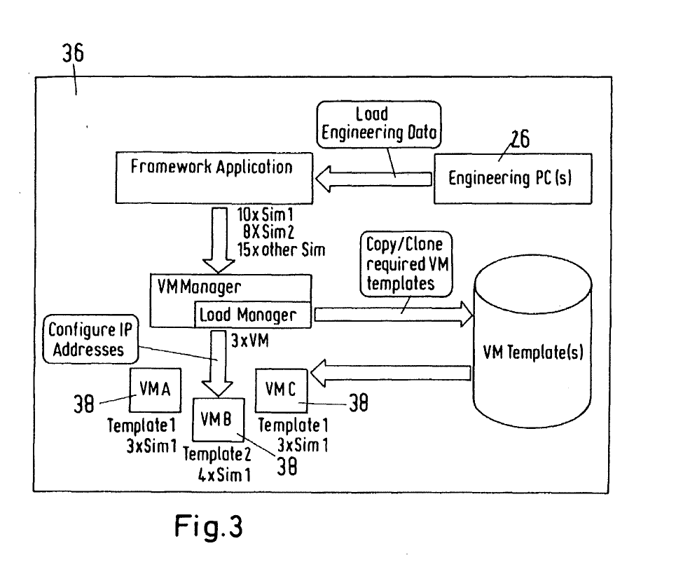

FIG. 3 shows an arrangement 36 of the specific components and tools being used for simulation according to an exemplary embodiment of the present disclosure, whereas a user-defined number of virtual machines 38 (VMA, VMB, VMC) are used which are installed in one main engineering PC used for the plant solution.

Furthermore, there is a standard method that can be used to engineer simulation solutions of a plant. Accordingly, within the arrangement 36, the different tools such as a “Load Manager” within a “VM Manager” and process steps such as “load engineering Data” or “copa/clone required VM template” are depicted.

Firstly, the user configures the access to the main engineering PC 26 used for the plant solution. Then, the user configures the physical host PCs that are used for performing the virtual machines 38 containing the simulators—only the physical PC, not the virtual machines.

After that, the user selects the objects that should be simulated and then based on the engineering data provided by the engineering PC, a framework application is provided to configure the required simulators, the required network interface, and the required IP addresses as well as the load balancing of the simulation tools, the required number of virtual machines, and the distribution of virtual machines to the physical PCs.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for engineering a clustered simulation network using virtualization, the system comprising:
a main engineering personal computer (PC) being used for a plant solution and having user-configured access thereto;
physical host PCs configured to perform virtual PCs including
a. simulators which are user-configured to simulate physical systems of a plant automation system,
b. simulators configured to perform virtual network adapters for simulators of physical systems, and
c. simulation tools to control the simulators;
engineering data including information about a control, device and subsystem solution and corresponding logic behind the physical systems of the plant automation system stored in the engineering PC;
a framework application, which is, based on the engineering data received from the engineering PC, provided for a configuration of required simulators, a required network interface, required virtual PCs and virtual hardware, and required IP addresses,
wherein the framework application is configured to require a number of virtual PCs configured to perform simulation tools, and distribution of virtual PCs to the physical PCs, and
wherein the virtual PCs contain simulators of different types, interface and control functionality.

2. The system according to claim 1, comprising:
a configuration tool configured set up the simulation network itself, the configuration of the simulators to set up each simulator and make them perform the engineered control solution, and configure communication between the simulators.

3. The system according to claim 1, comprising:
a graphical user interface (GUI) of a virtual PC hypervisor configured to enable the user to perform orchestration commands from the GUI of the virtual PC hypervisor.

4. The system according to claim 1, wherein the framework application is configured to enable the user to perform orchestration commands remotely.

5. The system according to claim 3, wherein the clustered simulation network includes components including at least one of standard PC hardware, and network adapters in a physical PC due to networks which are tunneled through a hardware abstraction layer of the hypervisor.

6. The system according to claim 1, wherein the clustered simulation network includes components including at least one of standard PC hardware, and network adapters in a physical PC.

7. The system according to claim 1, wherein engineering is based on a defined standard workflow for all simulation tools.

8. The system according to claim 1, wherein an appropriate load balancing is calculated to distribute the VMs executing the simulators to several host PCs.

9. The system according to claim 8, wherein an appropriate load balancing of the simulation tools inside the virtual PCs being assigned to a specific host PC is calculated.

10. The system according to claim 7, wherein the simulation tools inside the virtual PCs are instantiated according to a load balancing scheme or as defined.

11. The system according to claim 7, wherein a minimum number of host PCs required to perform the simulation is calculated by means of predefined metrics.

12. The system according to claim 7, wherein control commands of the simulators are utilized to distribute and synchronize the simulators throughout the simulation network.

13. The system according to claim 10, comprising:
a graphical user interface (GUI) of a virtual PC hypervisor configured to enable the user to perform orchestration commands from the GUI of the virtual PC hypervisor,
wherein the orchestration commands of the virtual PC hypervisor are utilized to extend existing simulation tools with further control functionality.

14. The system according to claim 9, wherein the simulation tools inside the virtual PCs are instantiated according to a load balancing scheme or as defined.

15. The system according to claim 9, wherein a minimum number of host PCs required to perform the simulation is calculated by means of predefined metrics.

16. The system according to claim 9, wherein control commands of the simulators are utilized to distribute and synchronize the simulators throughout the simulation network.

17. The system according to claim 10, comprising:
a graphical user interface (GUI) of a virtual PC hypervisor configured to enable the user to perform orchestration commands from the GUI of the virtual PC hypervisor,
wherein the orchestration commands of the virtual PC hypervisor are utilized to extend existing simulation tools with further control functionality.

18. The system according to claim 1, wherein, for the configuration of the clustered simulation network, communication between an orchestration interface and the simulation tools and hypervisors of the virtual machine is provided in a networked manner.

19. The system according to claim 1, wherein simulators, simulation of the virtual PCs, or simulation of the physical PCs are added or removed from the simulation network while the simulation is executed without stopping or interrupting the execution of the simulation.

20. A method for engineering a clustered simulation network using virtualization, the method comprising:
configuring user access to a main engineering computer (PC) being used for a plant solution;
configuring user-configured physical host PCs for performing virtual PCs containing simulators;
selecting user-configured physical systems of a plant automation system for simulation; and
based on engineering data including information about a control, device and subsystem solution and corresponding logic behind the physical systems of the plant automation system stored in the engineering PC, a framework application
a. extracts required simulators, required network interfaces, required virtual PCs and required IP addresses, as well as a configuration of the virtual PCs and virtual hardware,
b. distributes and configures the simulators, network interfaces and IP addresses to the virtual PCs, and
c. distributes and configures the virtual PCs to the physical host PCs,
wherein the required number of virtual machines which perform simulation tools, and the distribution of virtual PCs to the physical PCs are configured by the framework application providing an appropriate load balancing which is calculated to distribute the virtual PCs to several host PCs, and
wherein the simulators are instantiated according to a load balancing scheme.

21. The method according to claim 20, comprising:
setting up the simulation network;
providing the configuration of the simulators into each simulator to set up the simulators and make the simulators perform an engineered control solution; and
configuring communication between the simulators.

22. The method according to claim 20, wherein the configuration is performed from a graphical user interface (GUI) of a virtual PC hypervisor or remotely controlled via the framework application.

23. The method according to claim 21, wherein the configuration is performed from a graphical user interface (GUI) of a virtual PC hypervisor or remotely controlled via the framework application.
